(19) United States
(12) Patent Application Publication
(10) Pub. No.: US 2007/0116199 A1
(43) Pub. Date: May 24, 2007

(54) Method, mobile device, system and software for establishing an audio note journal

(76) Inventors: Juha Arrasvuori, Tampere (FI); Pauli Laine, Espoo (FI); Kai Havukainen, Lempaala (FI); Antti Eronen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/282,961

(22) Filed: Nov. 17, 2005

(51) Int. Cl. H04M 1/64

(52) U.S. Cl. 379/68

(57) ABSTRACT

A method, apparatus, system, and software product are presented for storing and retrieving information about phone calls. At least part of a call is recorded, and that recording is stored. A link is established from a user calendar to the stored recording, the calendar also being used for other chronological information such as events, appointments, and the like. The stored recording is then accessible by activating the link in the calendar.

### FIELD OF THE INVENTION

Enhanced voice and journal (calendar and note) applications.

### BACKGROUND OF THE INVENTION

It is difficult to keep notes while making calls with a mobile phone, especially if the user is on the move. For years, it has been possible to record a phone conversation on a mobile phone, but it has been up to the user to keep a record of the person with whom the phone conversation occurred, and when it occurred.

It is known to use an electronic calendar to initiate calls, using a personal digital assistant software, such as the TARGET MOBILE POCKET EDITION. See www.targetsoftware.com/perspectives/salesrep.aspx (downloaded Oct. 19, 2005). However, keeping a record of mobile phone calls initiated by other means is still an unnecessarily difficult task.

Automatic logging of telephone calls has been accomplished in various contexts. For example, a group-oriented customer service, sales management, and contact management software program is known, such as the IDENTIFIER system from YES TELECOM. See www.yes-tele.com/mlm.html. It features instant and automatic database retrieval of customer records before the phone is answered, and automatic logging of all outgoing calls. It tracks name, phone number, time, date, length of call, and any notes. It categorizes and posts all incoming and outgoing phone call information to a daily ledger as well as an individual client file. It performs detailed phone use analysis by time of day, day of week, call source, number of rings, and unanswered calls. It includes an appointment scheduler for meetings, call backs to-do lists, and the like.

Nevertheless, there still exists no way to utilize sound recordings in such a system. Typically, sound recordings have not been widely employed, for reasons of privacy. Enabling a person to record telephone calls without the knowledge of another participant in the call has been considered an unappealing prospect. However, especially if privacy concerns are overcome, then sound recordings can become a useful tool for keeping phone call records.

It is known to watermark audio recordings. See, for example, Audio Watermarking and Applications by Eric Metois, http://xenia.media.mit.edu/·metois/Projects/Waterm/waterm.htm (downloaded 17 Nov. 2005). However, watermarking has not been utilized in the context of alerting people that the recording is taking place, so as to enhance privacy protection.

### SUMMARY OF THE INVENTION

The present invention is invisible to users in normal use. During a call, the user can press a button to start or stop sound recording. The sound recording is stored on the phone, along with information on the time and date of the call, the other party's number (or name, if already stored in a contacts database), and optionally some written notes made by the user. This information is stored into an audio note journal, which lists all calls made by the user. The entries in the audio note journal are linked into the contacts database, and are also linked into a calendar. The system automatically generates calendar entries of the calls for which notes have been made.

In order to save memory on the phone, the audio recording can later be uploaded to a PC when, for example, synchronizing the calendar or contact database.

The user can access the audio recording in three ways. First, the audio recording can be accessed by identifying the person (or the phone number) that was contacted. This way, the user can check what he has talked about with the person a week, or even months, ago. Second, the audio recording can be accessed by a theme of the call. In other words, a group of recordings of several calls made to different numbers, but all concerning a specific theme, can be accessed by identifying that theme. Third, the audio recording can be accessed via the calendar entry automatically generated from the call with audio notes. This way the person can browse, for example, the calls he/she made last Monday.

By having a button for starting and stopping recording, the user can omit recording things like small talk at the beginning of a conversation. And, speech recognition technology can be used to convert the speech to text, and store this data in the journal. This way, less memory is required, and the user can look at this data while making another phone call.

When a call is initiated by the user or by another party, a recording is created of at least part of the call, and this recording is stored. A link to the stored recording is inserted in a calendar having other information that is ordered by date, and perhaps also by time of day. Then the recording can be accessed via the link in the calendar. The calendar can be any time of chronological list, display, or the like. The recording can be a sound recording, or it can be text that has been automatically converted from sound.

Preferably, the user of a mobile device has the ability to program the device by choosing whether the default setting is to record phone calls absent user intervention, or whether the default is to not record unless there is user intervention.

In order to overcome privacy concerns, it is possible to provide an alert signal to all other call participants so that they are informed that recording is occurring. Additional privacy protection is obtainable by only allowing the alert signal to be disabled by stopping the creation of the recording.

Regarding the alert signal, that signal can be a sound that is mostly or entirely inaudible to humans, the sound being included in the recording so as to provide documentation that all parties were informed of the recording process. Of course, more than one party to a call can be recording at the same time, in which case there would be distinct inaudible sounds emanating from each party's mobile device. These sounds could last as long as the recording lasts, although it would alternatively be possible for these sounds to mark the beginning and the end of each recording.

It may be that, during coding and transmission, there will be band-limiting filtering which would filter out frequencies that are not within the range of human hearing. Thus, the alert signal can be put to a perceptually relevant part of the audio band, such that the signal will persist with different kinds of modifications during transmission. However, the signal would be designed such that it is inaudible or at least disturbs the original audio signal as little as possible. The problems and solutions here are analogous to those in audio watermarking, although the purpose of the signal in this application is different than in the field of audio watermarking.

This kind of alert signal could be detectable using a key, and in this case it might be public such that all call participants can detect the signal. However, the problem here is that we may not know whether the terminals of all participants will have such detection technology, unless acknowledgments are used. Thus, employing an audible record indication signal that is designed such that it is audible but minimally annoying should be considered as an option, instead of a signal that is completely inaudible by humans.

If more than one party desires a recording to be converted from audio to text, then unnecessary duplication of the speech recognition process can be avoided by performing that task only once, and providing one or more copies to the parties desiring text. Another way to increase efficiency is to upload audio recordings to a PC or the like, which has more storage space than a mobile device. Then the audio recordings could possibly be accessed via an additional phone call that connects the mobile device to the PC, or alternatively the user would have to be physically located at the PC in order to access the voice recording. The uploading of audio recordings to the PC would preferably occur when a mobile device already needs to communicate with the PC, such as during a synchronization of calendar information or contact database.

### BRIEF DESCRIPTION OF THE DRAWINGS

FIG. 1 is a flow chart showing a method according to one embodiment of the present invention.

FIG. 2 is a block diagram showing a mobile device according to one embodiment of the present invention.

### DETAILED DESCRIPTION OF THE INVENTION

The present invention implements a software application that can record audio from a phone call, access a calendar for time and date information, access caller information, store data on the phone, and link the phone call information into the contacts list and the calendar.

Optionally, the software can upload the data to a personal computer (PC). Many current phone models can handle this type of software, and so the invention will not necessarily require any hardware changes. However, upgraded speech recognition technology can be used in order to convert the speech to text, and store the data in the audio note journal. This should be considered an optional feature in the present invention.

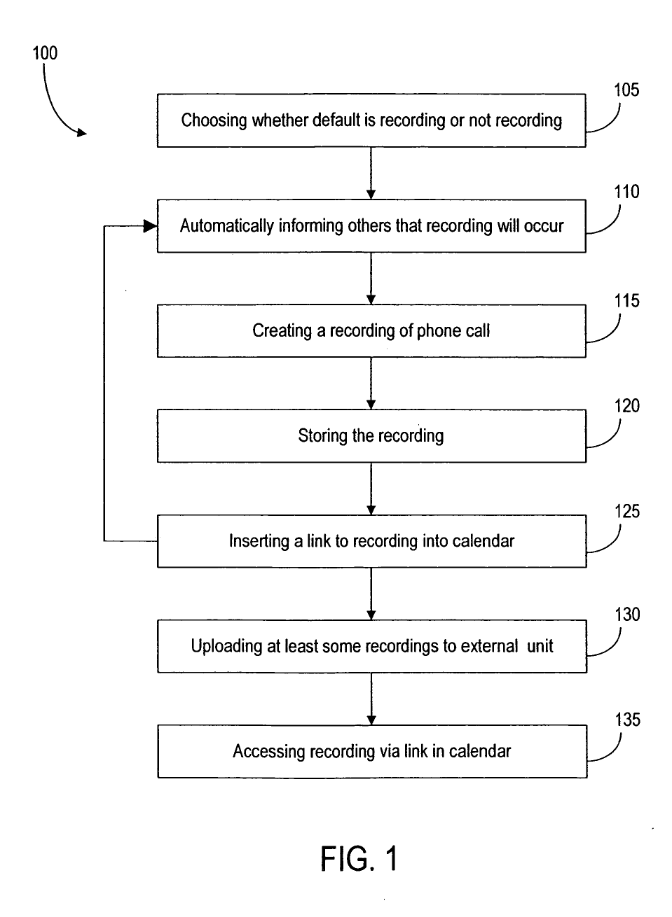

FIG. 1 shows an illustrative method 100 according to the present invention. First, the user chooses 105 whether the default will be recording or not recording. If the default is recording, then phone calls will automatically be recorded unless contrary action is taken. But, if the default is not recording, then the user will have to take the initiative each time recording is desired. This default will apply to a plurality of phone calls, unless or until the user changes the default. Of course, it is also possible to apply one default to one type of call (e.g. outgoing calls or calls with a particular person), and another default to another type of call (e.g. ingoing calls or calls with everyone but a particular person).

Once recording of a call begins, it is preferable that others will be automatically informed 110 that recording will occur or is occurring. According to this embodiment of the invention, the user cannot prevent such an alert, and thus the user cannot surreptitiously record private conversations without consent. Preferably, the alert is provided as an inaudible standardized signal that continues throughout the recording, and that is documented by the recording itself.

After the alert begins, the recording of the call is created 115. Then this recording is stored 120, either as audio or as converted to text. A link (e.g. a hyperlink) is then inserted 125 into a user calendar, so that the user can easily access the recording by date and/or time of day, the link being integrated with other chronologically arranged items in the calendar (e.g. appointments, events, or the like). This process repeats itself, until the mobile device uploads 130 at least some of the recordings to an external unit such as a personal computer (PC) which has more storage space than the mobile device. It can be advantageous, for example, to upload audio of a recording, while keeping text of the same recording in the mobile device. In any event, conversion to text can be performed by the PC during the uploading process, and the audio recording may or may not then be completely deleted and discarded, either immediately or after a certain time (e.g. one week).

The user is thus able to access 135 a plurality of recordings in text and/or audio form from an internal mobile unit and/or an external PC, simply by clicking on a link in the user's calendar.

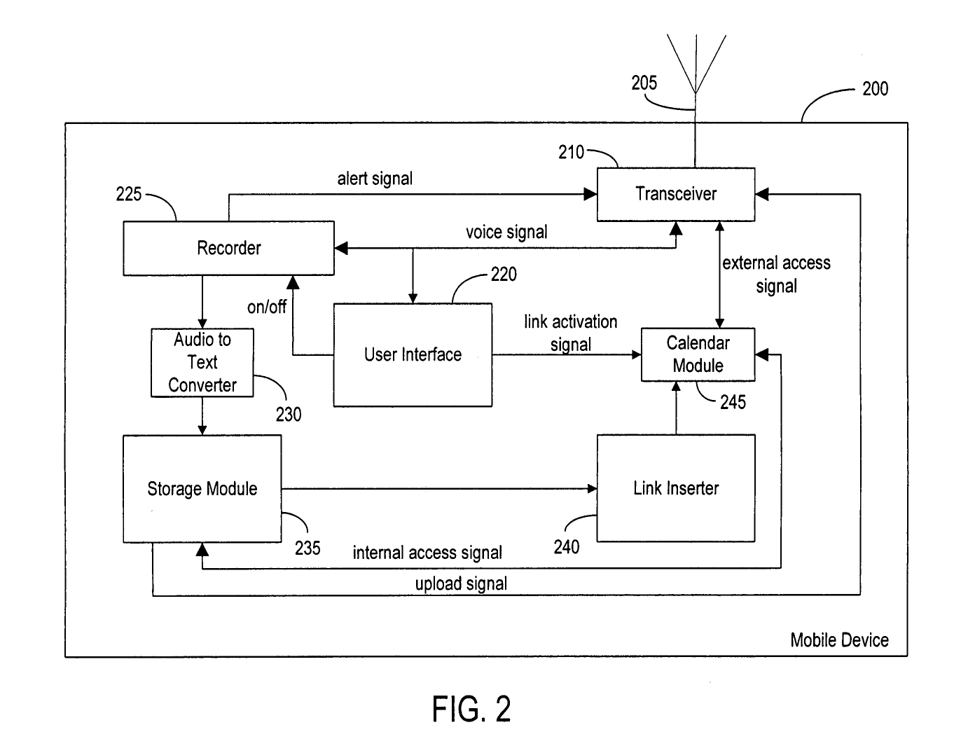

FIG. 2 shows a mobile device 200 according to an embodiment of the present invention. An antenna allows a transceiver 210 to communicate via a wireless telecommunications network. The user interface 220 sends and receives voice signals, and those voice signals can also be sent to a recorder 225. When the recorder is recording, an alert signal is provided to the transceiver in order to inform any other party or parties that the call is being recorded. The user interface 220 can instruct the recorder whether to operate, by sending an “on” or “off” signal. The recording is sent to a storage module 235, optionally through an audio to text converter 230. Once a recording is stored, a link is established by the link inserter 240 from a calendar module 245 to the recording. Thus, the user interface can send a link activation signal to the calendar module 245, and the calendar module will access the recording in the storage module 235 via an internal access signal. Occasionally, recordings from the storage module 235 can be uploaded to an external location via an upload signal. Thus, the calendar module can also access a recording via an external access signal.

The present invention can advantageously include the capability to receive comments to accompany the audio note, for example about the topic and purpose of the phone call, either as written text, or uttered words in the audio recording. This can be done before, during, or after the phone call.

In case of adding voice comments before or after the call, the user enables the audio recording for the microphone input of his terminal before or after the phone call. This is useful, because the user can, for example, add comments such as “Calling John Smith to propose our product X”. After the call, the user can add comments such as, “Our product got some interest, send the sales material by Monday.” The system may also be configured such that the system will automatically prompt the user to give short comments on the phone call, either before or after the call, or both.

Optionally, the system may be programmed to give follow-up alarms of past phone calls. For example, in the case above, the user would define after the call that the system should give a follow-up calendar alarm on Monday at 9:00 AM. When the follow-up calendar alarm occurs, it will identify, for example, that this is a follow-up calendar alarm related to the phone call with <Contact> on date <Date>. The fields <Contact> and <Date> are obtained from the respective information fields in the audio note calendar entry. In addition, the follow-up calendar entry will play or show the audio recordings or text comments made by the user before or after the call, or both. In the example discussed above, the system would play the user the recorded comments: “Our product got some interest, send the sales material by Monday.” The follow-up calendar alarm will also have a link to the phone call recording. This will be a useful feature, as the user can make a note immediately after the phone call about the actions that need to be done, but can postpone performing those actions to a later time.

Optionally, the user can also add the comments made after the call to a TODO list of the calendar. In this case, the TODO list of the calendar will have an entry such as a TODO item related to the call with <Contact> on <Date>. The TODO item will link to the comments made by the user after the call, for example “Our product got some interest, send the sales material by Monday.” The TODO list will also have links to the call recording, as well as all the comments made by the user relating to the call.

In case of adding voice comments during the call, the system mutes the outgoing audio channel such that the other participants in the call do not hear his/her comments. In the case of textual comments during the call, this is not needed. For both audio and text comments made during the call, the system stores timing information such that the comments are linked to the location of the original phone call when the user made these comments. This can be utilized to provide a view in the audio note viewing application where the user is able to see some representation of the audio recording, for example a bar or a schematic of the speech waveform, which also shows tags of the comments at proper time instants. From this view, the user can immediately skip to a location where he may have attached a comment like “Now he's telling about their new product, this is very interesting”, view or hear the comment, and start listening to the original audio note from this location.

The user can also add comments as images to the recorded phone call. For example, if the other call participant is showing slides which the other call participant can see in his/her terminal screen during the call, then the other user can take a screenshot of the terminal screen showing a slide and attach it to the corresponding place in the recorded phone call. Another possibility is that a call participant can draw notes with the drawing application of his/her terminal during the call, and then attach these notes as images to the recorded phone call. Yet another possibility is that a call participant writes notes or draws pictures with pen and paper during the call, and then takes a picture of the notes with the built in camera of the terminal, and attaches the picture of the notes into the recorded phone call.

It is to be understood that the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method of storing and retrieving information about phone calls, comprising:
creating a recording of at least part of a phone call;
storing the recording;
inserting a link to the stored recording, the link being inserted in an application having other information ordered at least by date; and
accessing the recording via the link in the application

2. The method of claim 1,
wherein the creating step is preceded by choosing between automatic recording of phone calls absent user intervention, and manual initiation of recording of phone calls.

3. The method of claim 1, further comprising a step of providing a prompt for comments about the phone call, wherein the prompt occurs before or after the creating step.

4. The method of claim 1, wherein the application is a calendar application, wherein the recording is in audio format, and wherein the other information is also ordered by time of day.

5. The method of claim 1, wherein the recording is text converted from audio via speech recognition technology.

6. The method of claim 1, further comprising automatically informing each other call participant that the recording is being created, by sending an alert signal indicative that the recording is being created, wherein the alert signal is resistant to being disabled except by stopping creation of the recording.

7. The method of claim 6, wherein the alert signal includes a sound inaudible or minimally audible to humans, the sound being included in the recording.

8. The method of claim 7, wherein the sound is distinguishable when more than one party to the phone call is creating a recording.

9. The method of claim 1, further comprising uploading the recording to an external memory unit.

10. The method of claim 9, wherein the accessing of the recording is accomplished via an additional phone call that connects to the external memory unit.

11. The method of claim 9, wherein the external memory unit is in a personal computer, and wherein the uploading occurs when a connection to the personal computer is established for at least one other purpose.

12. The method of claim 1, further comprising adding a voice comment, text comment, or an image to the recording.

13. A mobile device for storing and retrieving information about phone calls, comprising:
a recorder for creating a recording of at least part of a phone call;
a storage module for storing the recording;
a link inserter for inserting a link to the stored recording, the link being inserted in an application having other information ordered at least by date; and
a user interface for accessing the recording via the link in the application.

14. The mobile device of claim 13, wherein the user interface is also for enabling a user to choose between automatic recording of phone calls absent user intervention, and manual initiation of recording of phone calls.

15. The mobile device of claim 13, further comprising a prompting mechanism for soliciting comments about the phone call, before or after the recording is created.

16. The mobile device of claim 13, wherein the application is a calendar application, wherein the recording is in audio format, and wherein the other information is also ordered by time of day.

17. The mobile device of claim 13, wherein the recording is text converted from audio via speech recognition technology.

18. The mobile device of claim 13, further comprising a transceiver for automatically informing each other call participant that the recording is being created, by sending an alert signal indicative that the recording is being created, wherein the alert signal can only be disabled by stopping creation of the recording.

19. The mobile device of claim 18, wherein the alert signal includes a sound inaudible or minimally audible to humans, the sound being included in the recording.

20. The mobile device of claim 19, wherein the sound is distinguishable when more than one party to the phone call is creating a recording.

21. The mobile device of claim 13, further comprising means for uploading the recording to an external memory unit.

22. The mobile device of claim 21, wherein the accessing of the recording is accomplished via an additional phone call that connects to the external memory unit.

23. The mobile device of claim 21, wherein the external memory unit is in a personal computer, and wherein the uploading occurs when a connection to the personal computer is established for at least one other purpose.

24. The mobile device of claim 13, wherein the storage module is also for storing a voice comment, text comment, or an image related to the recording.

25. A system of storing and retrieving information about phone calls, comprising:
means for creating a recording of at least part of a phone call;
means for storing the recording;
means for inserting a link to the stored recording, the link being inserted in an application having other information ordered at least by date; and
means for accessing the recording via the link in the application.

26. A software product for storing and retrieving information about phone calls, the software product comprising a computer readable medium having executable codes embedded therein; the codes, when executed, adapted to carry out the steps of:
creating a recording of at least part of a phone call;
storing the recording;
inserting a link to the stored recording, the link being inserted in an application having other information ordered at least by date; and
accessing the recording via the link in the application.
